(19) United States
(12) Patent Application Publication
(10) Pub. No.: US 2004/0245425 A1
(43) Pub. Date: Dec. 9, 2004

(54) Hermetic mounting arrangement for optical and optoelectronic sub-assemblies

(76) Inventors: Franco Delpiano, Collegno (IT); Carlo Bruschi, Torino (IT)

Correspondence Address: PERMAN & GREEN, 425 POST ROAD, FAIRFIELD, CT, 06824, US

(21) Appl. No.: 10/849,638

(22) Filed: May 19, 2004

(30) Foreign Application Priority Data
May 23, 2003 (EP) 03253222.8

(51) Int. Cl. B42F 13/00

(52) U.S. Cl. 248/344

(57) ABSTRACT

A substantially planar substrate (10), typically constituting a part of a hybrid electro-optical device, has a portion (12) defining a mounting location for optoelectronic components (14) such as laser sources, photodetector diodes, LEDs, requiring local hermetic protection of the bare chips. A planar lightwave circuit (PLC) waveguide structure formed on the substrate (10) extends to the mounting location (12) to define an optical signal feed-through for the device. At least one electrode (20) is associated with the planar lightwave circuit waveguide structure (18) and extends said mounting location (12) to define an electrical signal feed-through for the device (14). A ring-like structure (26) continuously surrounds said mounting location (12). The ring-like structure (26) is hermetic with respect to the planar substrate (12), and a continuous cover member (28) is arranged to cover the mounting location (12) and having a peripheral rim portion (32) co-extensive with the ring-like structure (26). A hermetic sealing mass (30) extends continuously between the rim portion (32) of the cover member (28) and the ring-like structure, whereby the component (14) is hermetically sealed at said mounting location.

The invention relates to providing local hermetic sealing to components such as optical and optoelectronic devices mounted in more complex optical and electronic hybrid integrated arrangements.

The invention was developed by paying specific attention to the need of providing hermetic (e.g. liquid and gas proof) mounting arrangements with electrical and optical signal feed-through for electro-optical sub-units included in hybrid integrated optical and electronic devices.

The primary object of the invention is to limit the volume/extension to be hermetically sealed e.g. for the purpose of reducing cost and/or to avoid cross-contamination of components and materials enclosed in the same package due e.g. to organic compounds and vapour-releasing materials.

According to the present invention, that object is achieved by means of a mounting arrangement having the features set forth in the claims that follow.

The invention permits local hermetic sealing of optical or optoelectronic chips such as laser sources, photodetectors, LEDs mounted on a platform such as a glass or micromachined silicon platform, adapted to implement hybrid integrated circuits for electrical and optical signals.

A particularly preferred embodiment of the invention is a mounting arrangement including:

a substantially planar substrate having a portion defining a mounting location for a component such as an electro-optical device,

a component such as an electro-optical device (and the ancillary elements possibly associated therewith) mounted on said substrate at said mounting location,

a planar lightwave circuit (PLC) waveguide structure formed on said substrate, typically by conventional deposition and lithographic processes, and extending to said mounting location to define an hermetic optical signal feed-through for said component,

at least one electrode structure formed on said substrate, again typically by conventional deposition and lithographic processes, associated with said planar lightwave circuit waveguide structure and extending to said mounting location to define an hermetic electrical signal feed-through for said component,

a ring-like structure deposed on said optical and electrical feed-through structures, continuously surrounding said mounting location, said ring-like structure being hermetic to said planar substrate,

a continuous cover member arranged to cover said mounting location and having a peripheral rim portion co-extensive with said ring-like structure, and

a hermetic sealing mass extending continuously between said rim portion of said cover member and said ring-like structure, whereby said component is hermetically sealed at said mounting location.

The invention will now be described, by way of example only, with reference to the enclosed figures of drawing, wherein:

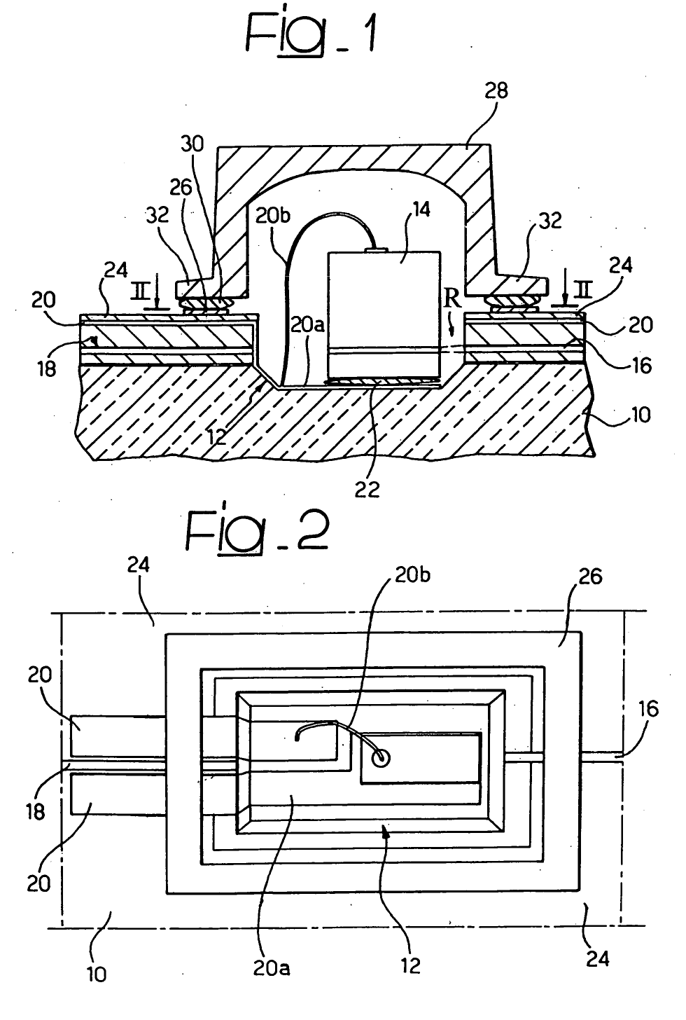

FIG. 1 is a cross sectional view of a mounting arrangement according to the invention, and

FIG. 2 is a sectional view essentially in the plane designated II-II in FIG. 1.

In FIG. 1, reference 10 designates a generally planar silica or silicon substrate having a portion defining a mounting region 12 for a device (“component”) 14 comprised e.g. of an optical or optoelectronic chip such as a laser diode, a photodetector, a LED and so on.

The mounting region 12 for the component may be coplanar to the upper surface of the substrate 10 or possibly comprise a “sculptured” portion, namely a portion recessed in the substrate 10 or a heightened (i.e. raised) portion of the substrate 10. Such sculpturing can be obtained by standard means e.g. by micromachining.

The substrate 10 is adapted for creating thereon, according to standard planar lightwave circuit (PLC) manufacturing processes, an optical waveguide structure extending inside the mounting location (i.e. an optical feed-through) at both sides (if required) of the mounting region 12.

Specifically, in the arrangement shown herein, the waveguide structure in question includes a PLC waveguide 16 adapted for optical coupling with the device/component 14. For instance, if the component 14 is a laser diode, the PLC waveguide 16 may be coupled in such a way that radiation R emitted from the laser source 14 is injected into and propagated along the waveguide 16.

In case, another PLC waveguide 18 extends in substantial alignment with the waveguide 16 from the other side of the mounting region 12, for example to collect the rear emission of the laser source 14 for external monitoring purposes.

A pattern of electrodes 20 can be deposited over the PLC waveguide structure. One or more of those electrodes extend (as shown at 20a) into the mounting region 12 (through any side) to form electrical contacts (i.e. an electrical feed-through) to the component 14 and any associated ancillary electrical or electro-optical devices included in the mounting region.

Specifically, the component 14 can be mounted and connected via its bottom surface to the electrode extension 20a by means of a soldering mass 22 or an equivalent electrical connection means.

Other electrical connections required to ensure operation of the component(s) in the region 12 may be produced by standard techniques (such as wire bonding, as shown at 20b) e.g. to connect the top termination of the component 14 to the second termination of the electrode 20 extending into the region 12.

A dielectric insulating layer 24 is formed over the PLC waveguide structure and the electrode 20 structure to produce a substantially planar and insulating layer surrounding the mounting location 12. A typical choice for the material comprising the dielectric insulating layer 24 is e.g. silica or silicon nitride, preferably deposited by chemical vapour deposition (CVD) techniques.

A ring-like formation 26, comprised e.g. of a conventional vacuum deposited Ti—Pt—Au metal stack, may thus be provided extending continuously around the mounting location 12 for the component 14.

In the exemplary embodiment shown herein, the ring-like formation 26 has a substantially rectangular shape. Those of skill in the art will promptly appreciate that such a shape however is in no way mandatory. In fact, the formation 26 is essentially provided as a basis member surrounding continuously and hermetically (i.e. without any breaks or holes) over the layer 24 and around the region 12. This in view of rendering the mounting region 12 hermetic by applying thereon a lid or cap 28, forming a cover member adapted to be continuously and hermetically connected (e.g. by means of a soldering mass 30) to the ring formation 26, thus producing a hermetic structure encapsulating the component 14.

In brief, the ring formation 26 continuously surrounds the mounting location 12 of the component 14 and is hermetic to the planar substrate 10 (through the hermetic layers 24,20,16,18). In fact, no apertures, discontinuities, liquid or gas permeable features exist in the ring formation 26 that may permit liquids and/or gases to leak therethrough in an appreciable amount.

Preferably, the cover member 28 has a general cup-like configuration with a flat flange 32 extending from and around its mouth portion.

As best appreciated in FIG. 1, this latter portion faces downwardly when the cover member 28 is applied over and around the mounting region 12. Once the cover member 28 is applied to cover the component 14 with the flange 32 sealingly connected (e.g. soldered at 30) to the ring formation 26, the component 14 mounted on the substrate 10 is sealingly (i.e. hermetically) isolated from the outer environment and from possible cross-contamination by components/materials enclosed in the same package, e.g. due to organic compounds or vapour-releasing materials.

The component 14 (in particular its optical surfaces, that may be very sensitive) is protected with respect to the outer environment by the cap or lid 28. This is preferably comprised of a metal or ceramic cap soldered to the metal ring 26. This result is achieved by limiting the volume/extension that is hermetically sealed with considerable advantages in term of costs.

This arrangement can be easily implemented by using standard lithographic processes to define the sealing metal annular structure 26 while metal caps 28 with flat flanges 32 can be easily manufactured at low cost.

The arrangement shown also avoids the use of enclosures including optical windows implying optical waveguide discontinuity. In fact, the component 14 is optically coupled to the outside via the PLC waveguide 16 that comprises a completely hermetic optical signal feed-through.

The electrodes 20 ensure electrical signal feed-through. These are adapted to be manufactured with a high degree of accuracy by resorting to standard metallisation processes, while in no way adversely affecting the hermetic nature of the sealing arrangement provided around the component 14.

Those of skill in the art will promptly appreciate that providing a recessed area such as area 12 in the substrate 10 or a similarly heightened area (by standard micromachining) is a preferred, yet not mandatory feature of the arrangement shown to adapt the optical height between the component 40 and the optical waveguides 16,18 for the purpose of optimising the coupling therebetween.

Similarly, at least in the case of very “shallow” components, e.g. components having a reduced height with respect to the general plane of the substrate 10, the cap or lid 28 may be provided in the form of a flat or approximately flat cover lid adapted to be soldered or otherwise connected to the ring structure 26 along its outer periphery.

Of course, without prejudice to the underlying principles of the invention, the embodiments and details may vary, also significantly, with respect to what has been previously described and shown, by way of example only, without departing from the scope of the invention, as defined by the claims that follow. Specifically, it will be appreciated that any feature previously disclosed in connection with a given embodiment can be freely adapted to any other embodiment of the invention. Also, terms such as “optical”, “light”, “photosensitive”, and the like are used herein with the meaning currently allotted to those terms in fiber and integrated optics, being thus intended to apply to radiation including, in addition to visible light, e.g. also infrared and ultraviolet radiation.

1. A mounting arrangement including:
a substantially planar substrate having a portion defining a mounting location for at least one optoelectronic component,
the at least one optoelectronic component mounted on said substrate at said mounting location,
at least one planar lightwave circuit waveguide structure formed on said substrate and extending to said mounting location to define an optical signal feed-through for said at least one component,
at least one electrode associated with said planar lightwave circuit waveguide structure, said at least one electrode extending to said mounting location to define an electrical signal feed-through for said at least one component,
a ring-like structure continuously surrounding said mounting location, said ring-like structure being hermetic to said planar substrate, and
a continuous cover member arranged to cover said mounting location and having a peripheral rim portion co-extensive with said ring-like structure, and
a hermetic sealing mass extending continuously between said rim portion of said cover member and said ring-like structure, whereby said at least one component is hermetically sealed at said mounting location.

2. The arrangement of claim 1, wherein said substrate is comprised of one of a glass, silicon or ceramic platform.

3. The arrangement of claim 1, wherein said planar substrate has a sculptured portion defining said mounting location for said at least one component.

4. The arrangement of claim 1, including a dielectric layer at least marginally covering said substrate, wherein said ring-like structure is provided over said dielectric layer.

5. The arrangement of claim 1, wherein said ring-like structure is comprised of a metal material.

6. The arrangement of claim 1, wherein said cover member is a cup-like member.

7. The arrangement of claim 1, wherein said cover member has a peripheral flat flange defining said peripheral rim.

8. The arrangement of claim 1, wherein the hermetic sealing mass is a soldering mass between said peripheral rim of said cover member and said ring-like formation.

9. The arrangement of claim 1, wherein said at least one component has an associated mass of solder providing electrical connection to said at least one electrode.

10. The arrangement of claim 1, wherein said at least one component has at least one associated wire bonding element providing electrical connection to said at least one electrode.

11. The arrangement of claim 1, wherein said cover member comprises a metal material.

12. A mounting arrangement comprising:
a substantially planar substrate having a portion defining a mounting location for a component,
at least one of the component mounted on said substrate at said mounting location,
at least one planar lightwave circuit waveguide structure formed on said substrate and extending to said mounting location to define an hermetic optical signal feed-through for said component,
at least one electrode structure formed on said substrate associated with said planar lightwave circuit waveguide structure and extending to said mounting location to define an hermetic electrical signal feed-through for said component,
a ring-like structure deposed on said optical and electrical feed-through structures, continuously surrounding said mounting location, said ring-like structure being hermetic to said planar substrate,
a continuous cover member arranged to cover said mounting location and having a peripheral rim portion co-extensive with said ring-like structure, and
a hermetic sealing mass extending continuously between said rim portion of said cover member and said ring-like structure, whereby said component is hermetically sealed at said mounting location.

13. The mounting arrangement of claim 12, wherein the component comprises an electro-optical device.
